(19) United States
(12) Patent Application Publication
(10) Pub. No.: US 2021/0164730 A1
(43) Pub. Date: Jun. 3, 2021

(54) COMBINED CRUSHING GRANULATION DRIER

(71) Applicant: Yuancai ZHANG, Jingjiang, Taizhou, Jiangsu (CN)

(72) Inventor: Yuancai ZHANG, Jingjiang, Taizhou, Jiangsu (CN)

(21) Appl. No.: 16/771,539

(22) PCT Filed: Dec. 10, 2018
(86) PCT No.: PCT/CN2018/120071

§ 371 Date: Jun. 10, 2020

(30) Foreign Application Priority Data
Dec. 11, 2017 (CN) 201721705506.8

(51) Int. Cl. F26B 25/16; B01J 2/12; B02C 4/02; B02C 4/30; F26B 25/20

(52) U.S. Cl. CPC F26B 25/16; B01J 2/12; F26B 25/20; B02C 4/30; B02C 4/02

(57) ABSTRACT

A combined crushing granulation drier has a combined tank, which is provided with a plurality of layers or a single layer. Two adjacent layers of tank bodies of the combined tank are connected by granulator connecting flanges. The granulator connecting flanges are arranged on the inner side of the combined tank. The ends of the flanges are fixed by bolts to form a fast-assembly type structure. A feed temporary storage bin is arranged at the upper part of the combined tank. The feed temporary storage bin and the tank body at the uppermost layer of the combined tank are connected, fixed and sealed by connecting flanges of the feed temporary storage bin. The combined tank is internally provided with a rolling unit. Each layer of rolling drum is internally provided with a rotating speed sensor.

### TECHNICAL FIELD

The present disclosure relates to the field of wet drying, in particular to a combined crushing granulation drier.

### BACKGROUND

The patent with the application number being CN2161813851.7 discloses a combined granulator which performs same-speed or differential-speed repeated granulation by applying self gravity of a pulpy, mushy, pasty or massive material, and thus realizing surfacing of water in a particle material to the maximum, greatly improving the material drying power and providing reliable guarantee for saving drying heat energy, lowering power consumption and prolonging the service life of a device; and the combined granulator is simple in structure, convenient to operate, small in friction and high in efficiency, converts the adverse characteristics of softness, viscosity, thickness, poor air permeability and the like of the material self to drying to advantages for combined granulation, and thus the pasty, mushy, pulpy, caky or massive material is directly converted to monomer particles, the surfaces of which are dried and provided with cracks, which are not mutually adhered and the middles of which are provided with pores, under the conditions of only needing to use very small power for driving a rolling machine self and low-speed, same-speed or differential-speed jerking of the materials (in a very small region), which pull the edges of teeth in an approximate sliding manner, on the surfaces of a small part of tooth rotary drums. Through repeated combination for many times, the water in the material may be surfaced to the maximum, the material drying power is greatly improved, and thus subsequent drying process is more facilitated, and consumption of kinetic energy and the heat energy is lowered; and a particle shape with many gaps in the middle can be formed during repeated granulation, and therefore, the air permeability of the particles is improved, and quick evaporation of the water in the particles is more facilitated.

For the combined granulator, by adopting a simple elastic tool holder or material retaining device, under the effect of mechanics, hard foreign matters mixed in a dry soft material are stripped or rejected; and after gathering to a certain amount, the hard foreign matters which appear after being stripped are very easily discharged manually, and therefore, the combined granulator is a most direct and simple method for solving the sorting problem of the hard foreign matters in soft, wet and viscous matters, and normal running of a system is ensured. By applying multi-start spiral grooves and many radial tooth grooves to form a reticular helical toothed cut surface, the massive and caky materials can be successfully encroached, jerking force is further balanced due to arrangement of the multi-start spiral grooves at the same time, and therefore, working impulse inertia is avoided, stress of the device is balanced and is more stable, and low-power running is obtained; and due to an indented structure, the relatively hard massive material is easily cut up under the condition of using very low power. For tooth tips, in alternate and reticular arrangement, of the multi-start spiral grooves, the tooth tips may be arranged along spiral lines rather than being orderly arranged in buses of the rolling machine rotary drums, and therefore, when the materials are cut into the device, the phenomenon of impulse stress may be avoided, and flexible and balanced stress of each rotary drum is kept; and by arranging proper spiral angles, the materials may automatically slide out of skewed slots along with a small quantity of extrusion force or friction force in the spiral grooves to enter straight slots respectively and then are cleaned by cleaning cutters in the straight slots respectively.

By applying simple low-power, low-speed and same-speed or differential-speed jerking to perform pulling granulation on the massive material, the situation that a high-speed crushing machine cannot normally run for a long time as being blocked by adhesion of the locally wet material at a feed inlet of a plate and frame filter press is completely eradicated, the massive material is easily torn off, and the necessary condition is created for low power consumption of running; and a speed difference of two tooth surfaces may be caused by same-speed or differential-speed running of two rolling machine rotary drums, and the jerking situation is avoided from being formed by the “hard material extrusion process”. By matching with the effect of the tooth tips, in alternate and reticular arrangement, of the multi-start spiral grooves, the hard materials are torn off under the condition of very low kinetic energy. An essential mechanical difference exists between jerking and hard extrusion crushing, the two rolling machine rotary drums may cause slippage of the material by extrusion on the material when being at one speed, and a fault of the device caused by a powerful torque formed by shrinkage of a volume of the hard material in the extrusion process cannot be caused. Therefore, the granulator is suitable for sludge with more extensive soft and hard characteristics of the materials.

A damper is installed between the rolling machine rotary drums which roll oppositely at each layer: the damper generates motion interference on small particulate matters to force the particulate matters to participate to mixing granulation with large-particle and large-mass materials, an up-down flowing speed of the material in the granulator is balanced, more modeled small particles repeatedly participate to granulation, and therefore, a finished particle product more has the pore characteristic, particles with higher quality, more pores, uniform humidity, irregular shape and larger specific surface area are obtained, the molding rate and the porosity of the finished particle product are increased, better shape and body conditions are provided for accelerating evaporation, and a blockage fault is completely eradicated. By arranging the damper, all the materials can pass through heat exchange surfaces of the two rolling machine rotary drums and enter a granulation region during slow rotation of the two rolling machine rotary drums, and therefore, the total retention time of the materials is prolonged, the drying strength per unit of volume is enhanced, the heat exchange efficiency is effectively improved, and a thin pasty material can be wholly evaporated and dried.

However, for a cabinet in the prior art, the appearance effect is influenced, and the external heat dissipation area and an occupying space are large; and in addition, a part of the dampers or cleaning blades break down, or individual rolling machine breaks down self, the fault cannot be discovered timely to cause the situation that the rolling machine drums cannot normally run until being blocked, the fault can be discovered only when the whole device stops running, and thus large overhaul engineering and long time consumption can be caused, and a very large difficulty is brought to overhaul.

### SUMMARY

An objective of the present disclosure is to provide a combined crushing granulation drier which is simple in structure and convenient to operate as well as integrates crushing, granulation and drying; a combined cabinet is of a quick mounting structure, each two adjacent layers of the combined cabinet are connected by a granulator connecting flange, the granulator connecting flange is arranged on the inner side of the combined cabinet, each rolling machine drum is internally provided with a rotating speed sensor, an alarm device is arranged outsides the combined cabinet, and a movable door is arranged on one side of each layer of the combined cabinet; the technical problems are solved; in order to realize the objective of the present disclosure, the following technical solution is provided: A combined crushing granulation drier, comprising a combined cabinet, a feed temporary storage bin, a rolling unit, a heating system and a power system, the combined cabinet is provided with a plurality of layers or a single layer, an exhaust port is arranged at the uppermost layer of the combined cabinet, the lowest layer of the combined cabinet is equipped with an air inlet and a bottom supporting frame, the air inlet is arranged on the supporting frame; the feed temporary storage bin is arranged on the top of the combined cabinet, the feed temporary storage bin and the uppermost layer of the combined cabinet are connected, fixed and sealed by connecting flanges of the feed temporary storage bin; the combined cabinet is internally provided with the rolling unit, the rolling unit comprises at least two layer of rolling machine, each layer of rolling machine is provided with at least one set of rolling machine rotary drums, the rolling machine rotary drums are arranged up and down; the first layer of the rolling machine rotary drums are provided with elastic stripping frames or elastic stripping sheets respectively; a cleaning blade is arranged under each rolling machine rotary drum; dampers are arranged between two adjacent layers of the rolling machine rotary drums; wherein the combined cabinet is of a fast-assembly type structure, two adjacent layers of the combined cabinet are connected by granulator connecting flanges, the granulator connecting flange is arranged on the inner side of the combined cabinet and is fixedly connected with the combined cabinet by one or more bolts at the two ends in a positioning manner without a bolt in the middle, and the sealing performance of connection is ensured by rigidity; and an alarm device is arranged on the outer side of the combined cabinet, moving doors are arranged on the left side and the right side of the combined cabinet respectively, and each rolling drum of the combined crushing granulation drier is internally provided with a rotating speed sensor.

Preferably, the structure of each layer of the combined cabinet is identical.

Preferably, the amount of the layers of the combined cabinet may be increased or reduced depending on the requirements.

Preferably, each layer of the combined cabinet is internally provided with a customized C-shaped steel, and the customized C-shaped steel is formed by welding channel steel, square steel or H-shaped steel.

Preferably, the bolts of the combined cabinet are arranged to be eyebolts.

Preferably, the surface of each rolling machine rotary drum is provided with a radial annular groove.

Preferably, the surface of each rolling machine rotary drum is provided with a radial annular groove and a multi-start spiral groove, and the radial annular groove and the multi-start spiral groove are combined into alternate reticular arrangement to form an indented structure.

The present disclosure has the following beneficial technical effects: the combined crushing granulation drier is simple in structure, convenient to operate as well as rapid and convenient for overhaul; compared with the prior art, as the granulator connecting flange is arranged on the inner side of the combined cabinet, the appearance is neat with the heat dissipation area of the outer surface being reduced and is beautiful with an external space being saved; each rolling drum is internally provided with the rotating speed sensor, the alarm device is arranged on the outer side of the combined cabinet to be connected with the combined cabinet, each layer of the combined cabinet is provided with one movable door, the corresponding rotating speed sensor sends out alarm immediately and sends a fault signal to the external of the combined cabinet when rotation of each rolling machine drum is abnormal, operation may be automatically stopped immediately, which layer of the rolling drums is judged to break down by an alarm signal lamp, the movable door of the layer of the combined cabinet may be opened, and therefore, the time and the labor are saved for overhaul, and the situation that the work progress is delayed by a fault of the whole device to cause a loss is avoided. Furthermore, for the combined crushing granulation drier provided by the present disclosure, the number of the layers of the granulator may be optionally increased or reduced according to the needs for the treatment ability and the characteristics of the material, adjustment may further be performed to meet the requirements for the characteristics of the material of a specific project after field debugging, and the flexibility is better than that of any other drying device.

### BRIEF DESCRIPTION OF DRAWINGS

FIG. 1 is a schematic diagram of a cross section of a single set of rolling rotary drums of the combined granulator of the present disclosure (side view);

FIG. 2 is a schematic diagram of pairing of a single set of rolling rotary drums of the combined granulator of the present disclosure (vertical view);

FIG. 3 is a schematic diagram of a structure of multiple layers in a single set of the combined granulator of the present disclosure;

FIG. 4 is a schematic diagram of a structure with multiple sets and multiple layers of the combined granulator of the present disclosure;

FIG. 5 shows rectangular reticular tooth grooves of each rotary drum of the present disclosure;

FIG. 6 shows the engaging condition of reticular teeth of each rotary drum of the present disclosure;

FIG. 7 shows conical reticular tooth grooves of each rotary drum of the present disclosure;

FIG. 8 is a schematic diagram of a structure of a combined cabinet of the present disclosure;

FIG. 9 is a schematic diagram of radial annular grooves formed in the surfaces of the rotary drums of the present disclosure.

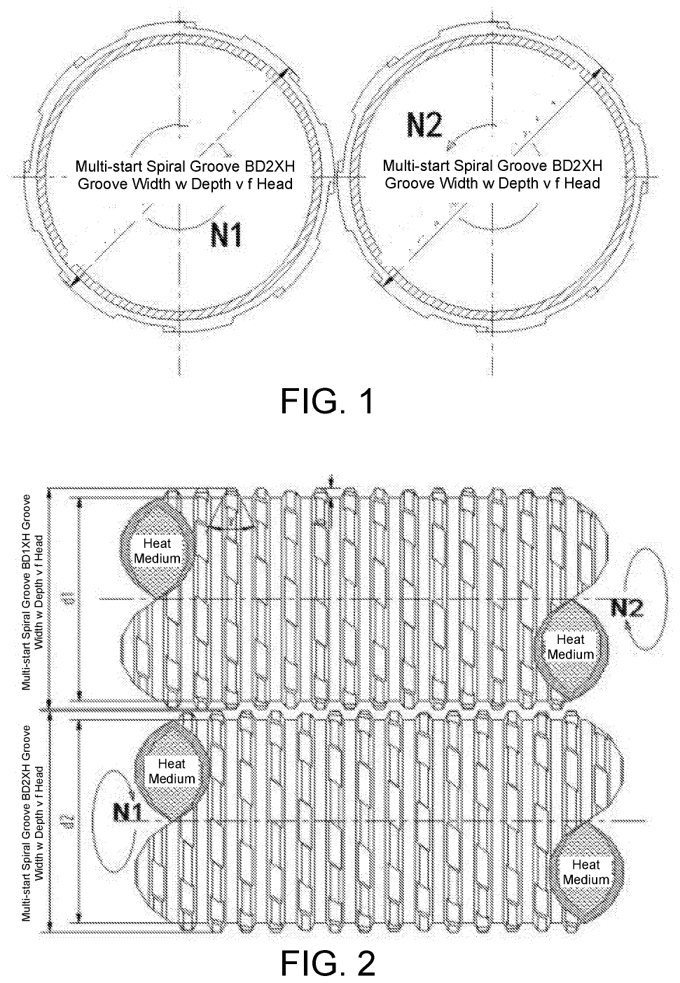

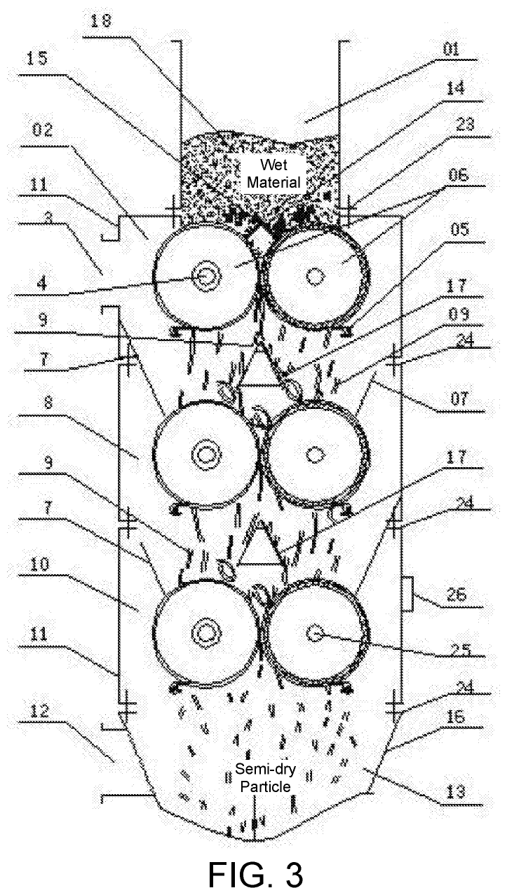

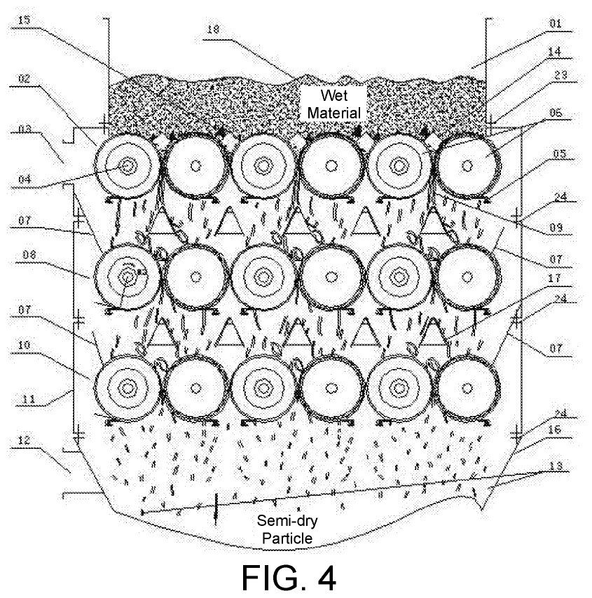

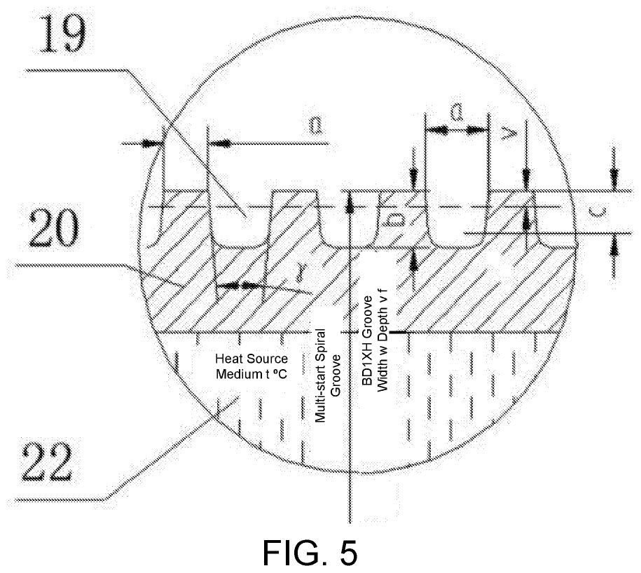

1 feeding temporary storage bin, 2 first layer of rolling machine, 3 exhaust port, 4 steam swivel joint, 5 cleaning blade, 6 rolling machine rotary drum, 07 material retaining plate, 8 second layer of rolling machine, 09 strip material, 10 nth layer of rolling machine, 11 combined cabinet, 11-1 customized C-shaped steel, 12 air inlet, 13 semi-dry particle, 14 elastic stripping frame, 15 hard foreign matter, 16 supporting frame, 17 damper, 18 wet material, 19 flat-bottom tooth groove, 20 rolling machine rotary drum wall, 21 engaging and molding groove, 22 heat source medium, 23 connecting flange of feeding temporary storage bin, 24 connecting flange, 25 rotating speed sensor, 26 alarm device, 27 movable door.

### DETAILED DESCRIPTION OF THE EMBODIMENTS

In order to make the purpose, the technical solution and the advantages of the present disclosure more clearly and unambiguously, the present disclosure is further clarified based on the following drawings and specific examples in specific embodiments.

In the drawings, the combined crushing granulation drier includes a combined cabinet, a feeding temporary storage bin, a rolling unit, a heat-supply system and a power system, the combined cabinet 11 is provided with several layers or a single layer, an exhaust port 3 is arranged at the uppermost layer of the combined cabinet 11, the lowest layer of the combined cabinet 11 is equipped with an air inlet 12 and a bottom supporting frame 16, and the air inlet 12 is formed in the supporting frame 16; the feeding temporary storage bin 1 is arranged at the upper part of the combined cabinet 11, and the feeding temporary storage bin 1 and the uppermost layer of the combined cabinet 11 are connected, fixed and sealed by a connecting flange 23 of the feeding temporary storage bin; the combined cabinet 11 is internally provided with the rolling unit, the rolling unit includes at least one layer of rolling machine, each layer of the rolling machine is provided with at least one set of rolling machine rotary drums 6, and the rolling machine rotary drums 6 are arranged up and down; a first layer of the rolling machine rotary drums 6 is provided with an elastic stripping frame or an elastic stripping sheet 14; a cleaning blade 5 is arranged under each of the rolling machine rotary drums 6; and a damper 17 is arranged between two adjacent layers of the rolling machine rotary drums; wherein the combined cabinet 11 is of a quick mounting structure, two adjacent layers of the cabinet are connected by a granulator connecting flange 24, the granulator connecting flange 24 is arranged on the inner side of the combined cabinet 11 and is fixedly connected with the combined cabinet by one or more bolts at the two ends in a positioning manner without a bolt in the middle, and the sealing performance of connection is ensured by rigidity; and an alarm device 26 is arranged on the outer side of the combined cabinet 11, a movable door 27 is arranged on the left side and the right side of the combined cabinet 11, and each rolling drum of the combined crushing granulation drier is internally provided with a rotating speed sensor 25.

The structure of each layer of the combined cabinet is identical; accessories of the combined cabinet are increased or reduced according to the actual use needs and include a steam inlet, a condensed water outlet, a connecting bolt and the like; the number of the combined cabinet 11 may be increased and reduced according to the needs; each layer of the combined cabinet is internally provided with a customized C-shaped steel; the customized C-shaped steel is formed by welding a channel steel, a square steel or an H-shaped steel; bolts of the combined cabinet are arranged to be eyebolts; the surface of each rolling machine rotary drum 6 is provided with a radial annular groove; the surface of each rolling machine rotary drum 6 is provided with a radial annular groove and a multi-start spiral groove, and the radial annular groove and the multi-start spiral groove are combined into alternate reticular arrangement to form an indented structure; and a motion speed of each roller of the present disclosure is divided into same-speed motion and differential-speed motion, the same-speed motion may be used when the material is soft material in characteristic, and the differential-speed motion should be selected when the material has soft material characteristic and hard material characteristic at the same time.

The present disclosure discloses a combined crushing granulation drier, including main components such as a feeding temporary storage bin 1, a first layer of rolling machine 2, a second layer of rolling machine 8, an nth layer of rolling machine 10, a combined cabinet 11, a power system and a granulator supporting frame 16, wherein the combined cabinet 11 is a multi-layer cabinet of a quick mounting structure and may further be a single-layer cabinet by being fixedly connected through multiple layers of granulator built-in flanges by bolts 24. The combined cabinet 11 of the device is equipped with an exhaust port 3, an air inlet 12, rolling machine rotary drums 6 and material retaining plates 7; each rolling machine rotary drum 6 of each layer of the rolling machine is provided with a steam swivel joint 4 and a cleaning blade 5; and each rotary drum 6 of the first layer of the rolling machine is provided with an elastic stripping frame (or an elastic stripping sheet) 14, each rotary drum 6 of each subsequent layer of the rolling machine is provided with a damper 17, and the connecting flange 23 of the feeding temporary storage bin and the multi-layer granulator connecting flange 24 finish configuration of the combined granulator.

The feeding temporary storage bin 1 is installed at the upper part of the combined cabinet 11 of the device, the wet material 18 is fully distributed on the first layer of the rolling machine 12 to enable the rolling machine to always keep a working state of full load, the interior of the combined cabinet keeps good negative pressure, the upper part of the first layer of the rolling machine 12 is partitioned, and air is avoided from being sucked into the device. The feeding temporary storage bin 1 is further provided with a material level sensor to send a material level signal into an automatic control system, timely supplement to the material in the bin is finished by a material conveying system, and a material layer is kept to be higher than or equal to a minimum thickness layer.

A suit of combined granulator of a single-set and multi-layer structure is usually formed by at least two or more layers of the rolling machines. Each layer of the rolling machine is provided with one set of rolling machine rotary drums 6 to form a single running layer; all the rolling machine rotary drums 6 are provided with common steam swivel joints 4, serving as important components for input and output of a heat source, respectively and are provided with the matched cleaning blades 5, serving as important components for cleaning residual materials in the reticular tooth grooves or single radial tooth grooves respectively; diameters of the rolling machine rotary drums 6, forms and sizes of the reticular tooth grooves or single radial tooth grooves may be identical or different; and in a whole design of the combined granulator, the design principle is that the material which falls to a position between the first layer and the second layer from the rolling machine rotary drums at the upper layer may be timely conveyed downwards by an adjacent lower layer of the rolling machine rotary drums. When an incoming material is the soft material, as the material at the first layer is large in pressure formed by a dead weight, high in humidity and soft in texture, and the material at the second layer is small in pressure formed by a dead weight, reduced in humidity and gradually hard in texture, when flow passing gap areas formed by rolling machine rotary drums which oppositely move are identical, the volume of the material falling from the first layer is larger than that of the material at the second layer, and the volume flow rate of the second layer is larger than that of the second layer. If the pressures formed by the dead weights of the materials at the subsequent lower layers are substantially identical, the speed ratio needs to be lowered, and the heat exchange efficiency of the rolling machine rotary drums needs to be improved according to the volume change feature of the materials under the condition that the material flowing through adjacent upper layers can be ensured to be enough to be taken away by the corresponding lower layers without causing blockage. By arranging the dampers 17 on each layer of the rolling machine rotary drums 6 after the first layer, the evaporation intensity is strengthened, straight flowing of small particles is blocked, the particle porosity is increased, and consumption of drying heat energy is lowered.

By mounting the elastic tool holder or the elastic stripping frame 14 at the upper part of the first layer, the soft material is pressed into the tooth grooves of the rolling machine due to the gravity pressure intensity, and hard foreign matters 15 are blocked on the elastic stripping frame 14. Along with motion of the rolling machine rotary drums, the soft material on the surfaces of the hard foreign matters 15 are stripped, the hard foreign matters 15 which may be embedded into gaps between the rolling machine rotary drums 6 and the elastic tool holder 14 are blocked and bounce to float on the elastic tool holder 14 under the elasticity effect of the elastic tool holder 14 during motion, the bounce ability is converted to an impulse power torque signal to be output to warn an operator to perform cleaning with shutdown when reaching a certain quantity.

Under the normal condition, a peripheral tooth surface linear speed and a volume flow rate of each rolling machine rotary drum 6 when the second layer of the rolling machine 8 rotates are higher than those when the first layer of the rolling machine 2 rotates; the tooth surface linear speed and the volume flow rate refer to a product of an area of a gap between teeth of the rolling machine rotary drums which oppositely move and a tangential linear speed of the rolling machine rotary drums respectively, that is a volume flow rate of the gap between the rolling machine rotary drums which oppositely move. A peripheral tooth surface linear speed and a volume flow rate of each rolling machine rotary drum when the nth layer of the rolling machine 10 rotates are higher than those when the n−1ₜₕ layer of the rolling machine rotary drums; and an increase speed depends on the volume property of the granulated material in the granulation and drying process. A material accumulation volume in the combined granulation and drying process is generally formed by three parts of a volume expansion region, a volume locking region and a volume reducing region from top to bottom; and when the volume is obviously reduced, the peripheral tooth surface linear speed and the volume flow rate of each rolling machine rotary drum when the lower layer of the rolling machine rotates are lower than those when the upper layer of the rolling machine rotary drums rotates. These would be determined according to the volume properties of the material at different water stages. As a common rolling machine, the cleaning blades 5 are installed at the lower end of the rolling machine to timely clean the materials in teeth of the rolling machine.

All the rolling machine rotary drums may be provided with steam swivel joints 4 of a heat source supply and output mechanism to continuously supply the heat energy.

The present disclosure provides three heat supply modes which are steam, heat conducting oil and hot flue gas or hot gas respectively; and the steam and the heat conducting oil are both an indirect heat exchange heat source, and the hot flue gas or the hot gas is a direct heat exchange heat source. The steam is a clean energy, and the heat conducting oil is a renewable energy.

The combined cabinet 11 of the device may be a single layer or combined, each layer of the rolling machine is generally installed in one independent cabinet, and the cabinets may be used by being combined up and down for multiple layers. The upper and lower layers of the cabinets may be designed into a unified mounting size to enable the combined granulator to be in multi-layer modular combination, and standard and scale production as well as increase or reduction in the number of layers and the heat exchange areas of the rolling machine of the combined granulator in the system debugging process are facilitated; and in particular cases, mounting of the multi-layer and multi-set rolling machine of the whole suit of the device may be further finished by one single-layer cabinet.

The first layer of the granulator is provided with the exhaust port 3, the supporting frame 16 is provided with the air inlet 12 formed in the lowest layer, and therefore, exhaust gas produced by evaporation may be timely exhausted, the moisture content in the cabinet is lowered, and the working evaporation power is strengthened; and each layer of the cabinet includes a material retaining plate 07 to guide the material to enter the lower layer of the rolling machine for work. Each material retaining plate 07 is extended to become a baffle plate of interior gas when being designed at a proper position, a gas flow in the whole cabinet after being combined gradually passes through each layer of the rolling machine according to a certain designed flow direction under the guidance of the baffle plate, evaporated water vapour is taken away by the gas flow, and the drying power is strengthened.

The lowest end of the combined cabinet is connected with the supporting frame 16. The supporting frame 16 is provided with the air inlet 12; the granulator supporting frame 16 may be further formed by supporting of a downstream device, such as a disc drier member, and particles discharged by the granulator may directly enter the downstream device for continuous drying without a conveying system in this case; and gas or a heat source needing to be supplemented may be further directly provided by a connector of a device at the lower end.

An exhaust mode of the gas in the combined cabinet 11 may be sealed negative-pressure control air induction and may further be of a vacuum drawing or opened dissipation form. If incoming gas needs to be supplemented, an air preheating system may be arranged. If the content of some an element of the gas in the granulator needs to be controlled, a corresponding monitoring system may be arranged. Or a closed circulation system may further be internally provided with a bypass to exhaust the evaporated gas.

Transmission of the combined granulator: the steam swivel joint 4 is installed at one end of each rolling machine rotary drum 6, and a power transmission mechanism, such as a gear, a chain wheel, a transmission shaft, a reducer and a motor, is installed at the other end of each rolling machine rotary drum 6; and generally, each combined granulator is combined by one set of power, the reducer and the motor, the whole device is driven by the chain wheel to run, the gear or the transmission shaft may further be driven by multiple sets (containing more than two sets) of the power, sectional control is performed on a transmission speed by an automatic control system according to the characteristic needs for the linear speed of the material as well as the tooth surface linear speed and the volume flow rate of each reticular tooth groove or the single radial tooth groove.

Each layer of the combined granulator includes multiple sets of the rolling machine rotary drums, each pair of the rolling machine rotary drums form one set to form multiple rolling surfaces, the capacity of the feeding temporary storage bin 1 is further increased at the same time, the wet material conveying and rolling efficiency is improved, and thus the combined granulator is adapted to different needs.

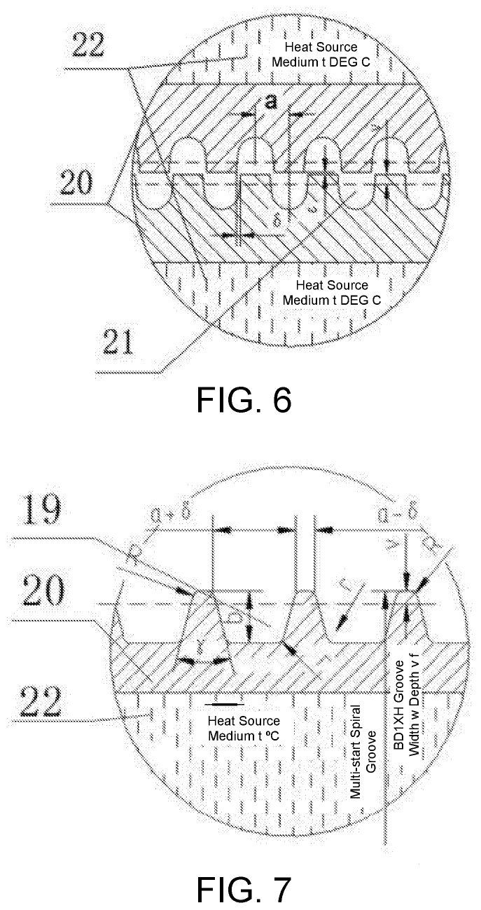

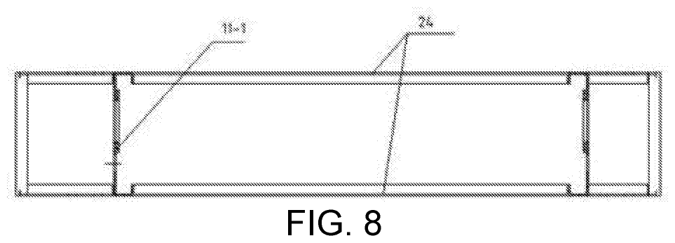

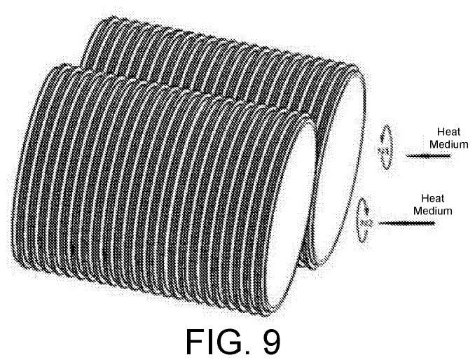

Layout of the rolling machine rotary drums may be designed into a single row with multiple layers, such as n layers, as shown in FIG. 6 and may further be designed into multiple rows (m rows) and multiple layers (n layers), as shown in FIG. 7.

The diameters (D1, D2, . . . Dn) of excircles of the rolling machine rotary drums: the diameters of the rotary drums may be identical (that is D1=D2= . . . =Dn) and may further be random values.

The diameter D of the excircle of each rotary drum is determined by the hardness and the flow characteristic of the material; if the diameter is large, a compression amount of the material in each rolling machine rotary drum by a first layer of strip material machine is large, the produced resistance is large, and the consumed power is high; and if the diameter is small, the heat exchange area of a single rolling machine rotary drum of the granulator is small, a device with the same evaporation ability is complex in matching due to increase in the number of shaft rollers, and the actual efficacy is lowered. Therefore, the design of the diameter of the excircle of each rolling machine rotary drum should satisfy successful modeling of a strip material (strip output of the material) on the premise of relatively low power consumption, and the purposes of saving energy, lowering consumption and finishing a granulation and drying task are achieved.

A size range of D may be in a range from 150 mm to 2000 mm, generally adopting 300 mm (c needs to be subtracted from a size value of an outside diameter of each actual rolling machine rotary drum).

D may be a random value, that is the diameter sizes of the strip material rolling machine rotary drums at one layer may be different, the diameter sizes of the strip material rolling machine rotary drums at different layers may further be different, and therefore, the combined granulator may also meet the production needs.

Under the condition of large number of the layers of the strip material machine, multiple power sources may be arranged for lightening a load of a driving shaft.

For a material with relatively small adhesion, when the pair numbers and the diameters of the strip material machines at the upper and lower layers are identical, rolling gaps in the middles of the strip material machines at the upper and lower layers would be vertical in one vertical line to cause the situation that the material vertically penetrates through the strip material machine layers without performing heat exchange in the lower layer to influence the heat transfer and granulation effect, and therefore, the strip material machines need to be arranged in a dislocation manner. The rolling gaps in the middles of the strip material machines may be dislocated in a vertical direction with different pair numbers of the rotary drums or different diameters of the rolling machine rotary drums, and a falling object may be arranged on each rolling machine rotary drum to exert the heat transfer effect.

When granulation is performed on a relatively hard material, different speeds (N1<N2) are adopted, the rotary drum on the left side exerts the effects of slowly supplying, remaining and jerking the material, the rotary drum on the right side exerts the effect of pulling the material, and the effect of pulling the massive material and the caky material is finished by opposite motion of the left and the right rotary drums; and when the granulated material is a uniformly soft material, N1=N2 may be adopted.

In the drawings, 21 refers to a engaging and molding groove, 22 refers to a heat source medium, and 20 refers to a rolling machine rotary drum wall; and a refers to a radial tooth width, b refers to a tooth depth, c refers to a distance between a tooth bottom circle center and the tooth surface, R refers to a tooth bottom circle radius, V refers to a depth of a multi-start spiral groove, and W refers to a width of the multi-start spiral groove, wherein y refers to a demoulding angle, and the demoulding angle would be determined by the viscosity, the humidity and the hardness of the material as well as the possible characteristics of hard gravels and the like in the material and generally takes a value ranging from 5 degrees to 90 degrees; and

δ refers to an engaging tooth tip axial gap, ε refers to an engaging tooth tip radial gap, δ and ε are determined by the hardness, the viscosity and the flowing feature of the material, and the objective is to provide enough gaps to ensure the motion interference phenomenon caused by thermal expansion of each rolling machine rotary drum as being heated on the basis of ensuring cutting and pulling molding (of the strip material).

α refers to an included angle between a connecting line of each tooth tips and an axis of the corresponding rolling machine rotary drum and a vertical symmetric center line of the axes of the rolling machine rotary drums and takes a value ranging from 5 degrees to 135 degrees, and the included angle is determined by arrangement and friction pressure angles of each layer of the combined granulator; for the rolling machine rotary drum at the edge, the angle is increased and generally adopts 15 degrees under the possible cabinet mounting space condition; for each rolling machine rotary drum in the middle of each layer of the cabinet, the angle may be arranged in a range from 5 degrees to 45 degrees only and generally adopts 15 degrees due to limitation to the mounting space of the cabinet; and β refers to an included angle between the bottom surface of a tooth sheet and a tangent line of the surface of a tooth bottom (excircle) at each tooth tips and takes a value ranging from 0 degree to 30 degrees, generally adopting 15 degrees, and a friction pressure angle is given to enable each blade to successfully clean the material in the corresponding groove.

θ refers to an included angle in the elastic tool holder and takes a value ranging from 60 degrees to 180 degrees, and the included angle is determined by the characteristics of the hard foreign matters which possibly exist and need to be rejected in the soft material.

τ refers to a gap between each elastic tool holder and the surface of an excircle of the corresponding rolling machine rotary drum 4, and the size of the gap is determined generally by the size characteristics of the hard foreign matters which possibly exist and need to be rejected in the soft material and ranges from 2 mm to 10 mm, generally taking a value of 5 mm.

For the combined granulator of the present disclosure, the connecting flange of the granulator is arranged on the inner side of the combined cabinet, and each layer of the combined cabinet is internally provided with the customized C-shaped steel; the customized C-shaped steel is formed by welding the channel steel, the square steel or the H-shaped steel, and the bolts of the combined cabinet are arranged to be the eyebolts; the appearance is neat with the heat dissipation area of the outer surface being reduced and is beautiful with an external space being saved; and each rolling drum is internally provided with the rotating speed sensor, a terminal box and the alarm device are arranged on the outer side of the combined cabinet to be connected with the combined cabinet, each layer of the combined cabinet is provided with one movable door, the corresponding rotating speed sensor sends out alarm immediately and sends a fault signal to the external of the combined cabinet when rotation of each rolling machine drum is abnormal, operation may be automatically stopped immediately, which layer of the rolling drums is judged to break down by an alarm signal lamp, the movable door of the layer of the combined cabinet may be opened, and therefore, the time and the labor are saved for overhaul, and the situation that the work progress is delayed by a fault of the whole device to cause a loss is avoided.

1. A combined crushing granulation drier, comprising a combined cabinet, a feed temporary storage bin, a rolling unit, a heating system and a power system, the combined cabinet (11) is provided with a plurality of layers or a single layer, an exhaust port (3) is arranged at the uppermost layer of the combined cabinet (11), the lowest layer of the combined cabinet (11) is equipped with an air inlet (12) and a bottom supporting frame (16), the air inlet (12) is arranged on the supporting frame (16); the feed temporary storage bin (1) is arranged on the top of the combined cabinet (11), the feed temporary storage bin (1) and the uppermost layer of the combined cabinet (11) are connected, fixed and sealed by connecting flanges (23) of the feed temporary storage bin; the combined cabinet (11) is internally provided with the rolling unit, the rolling unit comprises at least one layer of rolling machine, each layer of rolling machine is provided with at least one set of rolling machine rotary drums (6), the rolling machine rotary drums (6) are arranged up and down; the first layer of the rolling machine rotary drums (6) are provided with elastic stripping frames or elastic stripping sheets (14) respectively; a cleaning blade (5) is arranged under each rolling machine rotary drum (6); dampers(17) are arranged between two adjacent layers of the rolling machine rotary drums; wherein the combined cabinet (11) is of a fast-assembly type structure, two adjacent layers of the combined cabinet are connected by granulator connecting flanges (24), each granulator connecting flange (24) is an internal connecting flange, which is arranged on the inner side of the combined cabinet (11) and is fixedly connected with the combined cabinet by one or more bolts at the two ends of the internal flange in a positioning manner; an alarm device (26) is arranged on the outer side of the combined cabinet (11), moving doors (27) are arranged on the left side and the right side of the combined cabinet (11) respectively, and each rolling drum of the combined crushing granulation drier is internally provided with a rotating speed sensor (25).

2. The combined crushing granulation drier according to claim 1, wherein the structure of each layer of the combined cabinet are identical.

3. The combined crushing granulation drier according to claim 1, wherein the amount of the layers of the combined cabinet (11) may be increased or reduced depending on the requirements.

4. The combined crushing granulation drier according to claim 1, wherein each layer of the combined cabinet is internally provided with customized C-shaped steel (11-1), and the customized C-shaped steel is formed by welding channel steel, square steel or H-shaped steel.

5. The combined crushing granulation drier according to claim 1, wherein the bolts of the combined cabinet are arranged to be eyebolts.

6. The combined crushing granulation drier according to claim 1, wherein the surface of each rolling machine rotary drum (6) is provided with a radial annular groove.

7. The combined crushing granulation drier according to claim 1, wherein the surface of each rolling machine rotary drum (6) is provided with a radial annular groove and a multi-start spiral groove, and the radial annular groove and the multi-start spiral groove are combined into alternate reticular arrangement to form an indented structure.
